(19) United States
(12) Patent Application Publication
(10) Pub. No.: US 2025/0256472 A1
(43) Pub. Date: Aug. 14, 2025

(54) DRAINAGE MEMBRANE FOR THE MANUFACTURE OF COMPOSITE MATERIALS

(71) Applicant: SAFRAN, PARIS (FR)

(72) Inventors: Christophe RAVEY, MOISSY CRAMAYEL (FR); Romain VENAT, MOISSY CRAMAYEL (FR); Romain PICON, MOISSY CRAMAYEL (FR)

(21) Appl. No.: 19/112,837

(22) PCT Filed: Sep. 14, 2023
(86) PCT No.: PCT/FR2023/051400

§ 371 Date: Mar. 18, 2025

(30) Foreign Application Priority Data
Sep. 19, 2022 (FR) 2209406

(51) Int. Cl. B29C 70/48; B29C 70/24; B29C 70/54; B29K 707/04; B29K 709/02; B29K 709/08

(52) U.S. Cl. CPC B29C 70/48; B29C 70/24; B29C 70/546; B29K 2707/04; B29K 2709/02; B29K 2709/08; B29K 2713/00

(57) ABSTRACT

A method for manufacturing a part made of composite material, includes the arrangement of a fibrous preform in a mould including an impregnation chamber, the impregnation chamber being closed by a membrane separating the impregnation chamber from a compaction chamber, the injection of an impregnation fluid into the impregnation chamber, and the injection of a compression fluid into the compaction chamber so as to apply a pressure on the membrane, the aspiration of the compression fluid present in the compaction chamber, the surface of the membrane present on the side of the compaction chamber including a plurality of grooves.

### TECHNICAL FIELD

The present invention relates to the manufacture of parts made of composite material, in particular ceramic matrix composite material (CMC) or organic matrix composite material (OMC).

### PRIOR ART

The parts made of ceramic matrix composite material or organic matrix composite material are generally manufactured by impregnation of a fibrous preform. The fibrous preform can be arranged in a mould, closed by a counter-mould. The fibrous preform is then impregnated with a slip loaded with particles of a precursor matrix or with a resin, depending on the type of matrix desired. The impregnation is performed by injecting the slip or resin into the moulding cavity which contains the fibrous preform, so as to progressively penetrate the fibrous preform with the slip or resin.

Impregnation solutions using a mould and a counter-mould delimiting a moulding cavity are however not very satisfactory for the manufacture of certain parts, in particular for the manufacture of large or low-thickness parts, such as aircraft engine casings or aeronautical rear body parts. In addition, these solutions are very constraining from the point of view of tooling tolerances, which must comply with very precise dimensions.

In order to overcome these disadvantages, it is possible to use a deformable membrane instead of the counter-mould. Such a solution is described, for example, in documents US2017334791A1 and US2021046671A1, which describe methods in which a membrane separates an impregnation chamber from a compaction chamber. The preform is arranged in the impregnation chamber. In these methods, an impregnation fluid intended to penetrate into the pores of the preform is injected into the impregnation chamber, and a compression fluid is injected into the compaction chamber in order to apply a pressure on the membrane, the membrane thus applying a pressure on the fibrous preform. The injection parameters of the impregnation and compression fluids can vary according to the type of part to be produced.

When the fibrous preform is suitably impregnated, and after an optional treatment step of the impregnation fluid present in the preform, the compression fluid present in the compaction chamber is aspirated. However, it is observed that the residual compression liquid remains in the compaction chamber, and this even when the draining operation is repeated several times in succession. Thus, regular manual cleaning of the tooling is necessary to remove the compression fluid at the surface of the membrane and to remove the residual fluid still present in the compaction chamber. This manual cleaning operation is all the more problematic since the compression fluid used may present a risk to the health of individuals or to the environment, and may give rise to contamination problems in the workshop.

### DISCLOSURE OF THE INVENTION

An aim of the present invention is therefore to overcome the above-mentioned disadvantages, by proposing a solution for manufacturing a composite material part limiting the manual handling of the compression fluid. In particular, it has been observed that, during aspiration of the compression fluid for draining, the membrane could adhere to the wall of the compaction chamber under the effect of the aspiration, thus preventing removal of a portion of the compression fluid. This mechanism explains the rather large quantity of residual compression liquid in the compaction chamber, even after several successive draining cycles.

Thus, the invention proposes a method for manufacturing a composite material part comprising the following steps:
arranging a fibrous preform in a mould comprising an impregnation chamber by resting a first face of the preform on a support surface of the impregnation chamber, the impregnation chamber being closed by a flexible membrane placed facing a second face of the preform, said membrane separating the impregnation chamber from a compaction chamber,
injecting an impregnation fluid into the impregnation chamber,
injecting a compression fluid into the compaction chamber so as to apply a pressure on the membrane,
aspiration of the compression fluid present in the compaction chamber via one or more outlet orifices of the compaction chamber,
   the method being characterised in that the surface of the membrane present on the side of the compaction chamber comprises a plurality of grooves.

It has been observed that the presence of such grooves on the surface of the membrane makes it possible to reduce, in particular, the quantity of residual compression fluid present in the compaction chamber after draining, in other words after the aspiration of the compression fluid.

This improvement is explained by the presence of grooves at the surface of the membrane on the side of the compaction chamber, which, during the aspiration step, allow the circulation of the compression fluid between the membrane and the one or more walls of the compaction chamber when said membrane is pressed against one or more walls of the compaction chamber.

It can be provided, in particular, that a portion of the grooves opens into one or more outlet orifices when the membrane is pressed against at least one wall of the compaction chamber. The removal of the compression fluid is thus strongly facilitated during the aspiration step, and this even if the membrane is pressed against the one or more walls of the compaction chamber. In addition, this solution makes it possible to preserve a reduced size tooling, the compaction chamber not needing to be enlarged in order to avoid contact with the membrane. By preserving a compaction chamber with reduced dimensions, the implementation of the method is facilitated without needing to increase the quantity of compression fluid necessary for the correct operation of the tooling.

The impregnation fluid comprises one or more matrix precursors.

According to a particular embodiment of the invention, the grooves are disposed such that, when the membrane is in contact with a wall of the compaction chamber, typically during the aspiration step, at least a portion of the grooves opens into at least one outlet orifice of the compaction chamber or into a space of the compaction chamber comprising at least one outlet orifice.

Thus, the circulation of the compression fluid to the outlet orifice is facilitated when the membrane is aspired against a wall of the compaction chamber. Since almost all of the compression fluid is aspired, the loss of compression fluid during implementation of the method is limited, which makes it possible to reduce the quantity of compression fluid necessary.

According to another particular embodiment of the invention, the grooves are interconnected. Thus, the circulation of the compression fluid in the grooves is improved, for example in order to bring the compression fluid more quickly to an outlet orifice.

According to another particular embodiment of the invention, the grooves form a two-dimensional network of grooves. According to another particular embodiment of the invention, the grooves form a grid pattern. Thus, a possible circulation of the compression fluid in all directions is obtained, with a membrane that is very easy to manufacture.

According to another particular embodiment of the invention, the membrane is reinforced by glass fibres or polyester fibres.

According to another particular embodiment of the invention, the compression fluid comprises at least one oil. The invention is particularly advantageous in the case where the compression fluid comprises an oil, or a substance that is hazardous to health or the environment, because it is then sought to limit as much as possible the interactions with the compression fluid or the risk of an uncontrolled leak of the compression fluid to the exterior of the tooling.

According to another particular embodiment of the invention, the impregnation fluid is a resin, the method further comprising a polymerisation step of the resin impregnating the fibrous preform after the steps of injecting impregnation fluid and compression fluid and before the step of aspiration of the compression fluid.

According to another particular embodiment of the invention, the fibrous preform is produced by three-dimensional weaving of fibres. Thus, since the fibrous preform is intended to form the fibrous reinforcement of a composite material part, the composite material obtained will have very good mechanical properties and a low risk of delamination.

The invention also relates to a system for manufacturing a composite material part, said system comprising:
a mould which comprises an impregnation chamber including a support surface intended to be in contact with a first face of a preform, the impregnation chamber being closed by a flexible membrane situated facing the support surface, said membrane separating the impregnation chamber from a compaction chamber,
a device for injecting an impregnation fluid comprising precursor matrix particles into the impregnation chamber,
a device for injecting a compression fluid into the compaction chamber, so as to apply a pressure on the membrane,
a device for aspiration of the compression fluid present in the compaction chamber via one or more outlet orifices,
   the system being characterised in that the face of the membrane present on the side of the compaction chamber comprises a plurality of grooves.

According to a particular embodiment of the invention, the grooves are disposed such that, when the membrane is in contact with a wall of the compaction chamber during the operation of the aspiration device, at least a portion of the grooves opens into at least one outlet orifice or into a space of the compaction chamber comprising at least one outlet orifice.

### BRIEF DESCRIPTION OF THE DRAWINGS

FIG. 1 is a schematic sectional view of a tooling according to the invention, in which tooling a fibrous preform is positioned.

FIG. 2 is a schematic perspective view of the membrane of the tooling of FIG. 1.

FIG. 3 is a partial schematic sectional view of the membrane of FIG. 2 illustrating three grooves in cross-section.

FIG. 4 is a schematic sectional view of the tooling of FIG. 1 during injection of the impregnation fluid.

FIG. 5 is a schematic sectional view of the tooling of FIG. 1 during injection of the compression fluid.

FIG. 6 is a schematic sectional view of the tooling of FIG. 1 during aspiration of the compression fluid.

### DESCRIPTION OF THE EMBODIMENTS

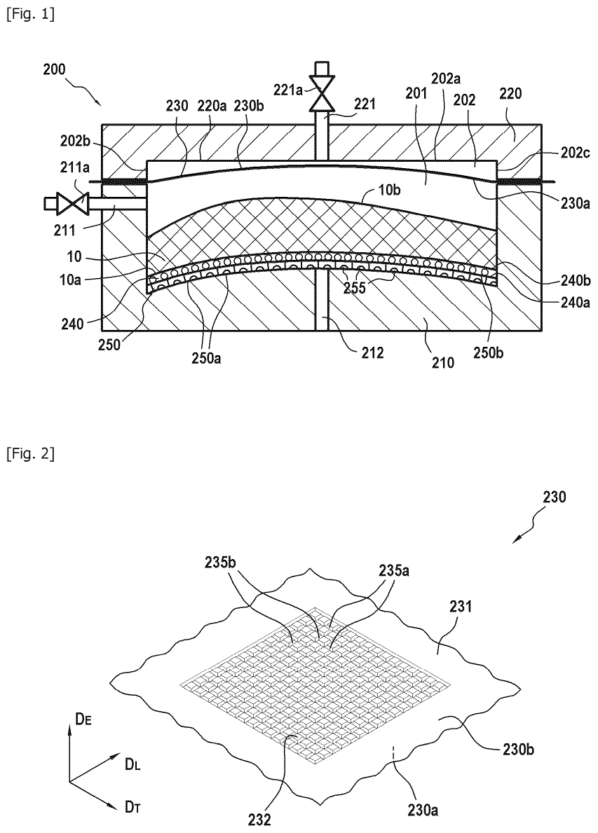

An exemplary system or tooling for manufacturing a composite material part according to the invention is illustrated in FIGS. 1 to 6. The manufacturing system 200 comprises a mould, which includes firstly an impregnation chamber 201 in which a fibrous preform 10 is arranged and, secondly, a compaction chamber 202.

An impregnation fluid 5 is intended to be injected into the impregnation chamber 201 and a compression fluid 6 is intended to be injected into the compaction chamber 202. Thus, the impregnation chamber 201 includes one or more inlet orifices 211 enabling the introduction of the impregnation fluid 5 into said impregnation chamber 201. The one or more inlet orifices 211 of the impregnation chamber 201 can be equipped with a valve 211a. The impregnation chamber 201 can also include one or more outlet orifices 212 enabling the removal of a portion of the impregnation fluid 5. Similarly, the compaction chamber 202 includes one or more inlet orifices 221 enabling the introduction of the compression fluid 6 into said compaction chamber 202, and one or more outlet orifices 221 enabling aspiration and removal of the compression fluid 6 present in said compaction chamber 202. The inlet and outlet orifices 221 of the compaction chamber 202 may be coincident, or at least partially coincident, as in the example illustrated in FIGS. 1 to 6. The one or more inlet orifices 221 of the compaction chamber 202 can be equipped with a valve 221a.

The fibrous preform 10 is intended to form the fibrous reinforcement of the composite material part to be manufactured. The fibrous preform 10 is considered here as the fibrous structure of the composite material part to be manufactured, obtained by any technique or combination of techniques for textile constitution, arrangement and deformation in order arrange it in the tooling 200.

The preform 10 can thus be at least partially produced by stacking layers or folds obtained by two-dimensional weaving (2D). The preform 10 can also be produced directly as a single piece by three-dimensional weaving (3D), or comprise at least one portion produced by three-dimensional weaving. Here “two-dimensional weaving” shall mean a conventional mode of weaving by which each weft yarn passes from one side to the other of yarns of a single warp layer, or vice versa. Here, the term “three-dimensional weaving” shall mean a weaving for which the warp yarns cross several layers of weft yarns, or the weft yarns cross several layers of warp yarns. A single weft yarn is thus interwoven with any plurality of different layers of warp yarns.

The preform 10 can also be at least partially produced by sheets of unidirectional fibres (UD), which can be obtained by depositing ribbons or by automated fibre placement (AFP), or by filament winding.

The preform 10 can be produced from ceramic fibres, from carbon fibres, or from a mixture of the two. In particular, the preform 10 can be produced from fibres consisting of the following materials: alumina, mullite, silica, aluminosilicate, borosilicate, silicon carbide, carbon or a mixture of several of these materials. The preform 10 can comprise any type of glass fibre, mixed or not mixed with other types of fibres.

The fibrous preform 10 can be produced by combining various weaving methods, or by combining various materials. For example, unidirectional fibre sheets can be inserted between folds produced by three-dimensional weaving.

The fibrous preform 10 comprises a first face 10a and a second face 10b, opposite the first face 10a.

As in the example illustrated in FIGS. 1 to 6, the impregnation chamber 201 can include a filtration layer 240 inserted between the fibrous preform 10 and the one or more outlet orifices 212 of the impregnation chamber 201. For example, when the impregnation fluid 5 is a slip composed of a liquid phase and precursor matrix particles, the filtration layer 240 can retain the precursor matrix particles in the preform 10 while allowing the liquid phase of the slip to pass. More generally, the filtration layer 240 can retain the one or more matrix precursors in the fibrous preform 10 and allow the remainder of the impregnation fluid 5 to pass, for example in order that the remainder of the impregnation fluid is removed via the outlet orifice 212 of the impregnation chamber 201.

The filtration layer 240 comprises a first face 240a and a second face 240b, opposite the first face 240a. Preferably, the first face 10a of the preform 10 rests on the second face 240b of the filtration layer 240.

The filtration layer 240 can, for example, be produced from microporous polytetrafluoroethylene (PTFE), but also from plaster or paper. In order to produce the filtration layer 240, a material having a pore size between 1 μm and 5 μm can be used, for example. The filtration layer 240 can have a resultant permeability between 10⁻¹⁴ m² and 10⁻¹⁵ m².

As in the example illustrated in FIGS. 1 to 6, when the tooling comprises a filtration layer 240, the impregnation chamber 201 can likewise include a rigid perforated element 250 interposed between the filtration layer 240 and the one or more outlet orifices 212 of the impregnation chamber 201. More precisely, a first face 250a of the rigid perforated element 250 is in contact with the wall of the impregnation chamber 201 opposite the compaction chamber 202, or the rigid perforated element is coincident with the wall of the impregnation chamber 201 opposite the compaction chamber 202. A second face 250b of the rigid perforated element 250, opposite the first face 250a, can be in contact with the first face 240a of the filtration layer 240, in other words the first face 240a of the filtration layer 240 rests on the second face 250b of the rigid perforated element. Such a rigid perforated element 250 is described, in particular, in document US 20190134848 A1. The function of this rigid perforated element 250 is to facilitate the removal of the liquid phase having passed through the filtration layer 240 via the one or more outlet orifices 212, whatever its point of exit on the first face 240a of the filtration layer 240.

In order to further facilitate the removal of a portion of the impregnation fluid 5, the rigid perforated element can include cut-outs or cavities 255 between its openings.

A distribution element (not shown) can optionally be disposed between the filtration layer 240 and the rigid perforated element 250, said distribution element having a permeability greater than that of the filtration layer 240. Such a distribution element enables a more uniform flow velocity of the liquid phase inside the filtration layer 240 to be obtained. A first face of the distribution element then rests against the second face of the element of the rigid perforated element 250b, and a second face of the distribution element, opposite the first face of said distribution element, then rests against the first face 240a of the filtration layer 240.

The first face 10a of the preform 10 is in contact with a support surface of the impregnation chamber 201, and rests on said support surface of the impregnation chamber 201. In the example illustrated in FIGS. 1 to 6, the support surface of the impregnation chamber corresponds to the second face 240b of the filtration layer 240. Of course, it does not depart from the scope of the invention if the support surface of the impregnation chamber is a rigid wall of said impregnation chamber opposite the compaction chamber, or a face of a rigid perforated element, such as previously described. Preferably, when the impregnation fluid 5 is a slip comprising a liquid phase and precursor matrix particles, the first face 10a of the preform 10 rests on a filter or a filtration layer 240. Preferably, when the impregnation fluid is a resin, the first face 10a of the preform 10 rests on a wall of the impregnation chamber opposite the compaction chamber, or on a face of a rigid perforated element, such as previously described.

The impregnation chamber 201 and the compaction chamber 202 of the mould are separated by a supple membrane 230, in other words a flexible membrane 230. The flexible membrane 230 is placed facing the second face 10b of the preform 10. In the impregnation chamber 201, the flexible membrane 230 is preferably opposite the support surface of said impregnation chamber 201. The membrane 230 comprises a first surface 230a and a second surface 230b opposite the first surface 230a. The first surface 230a of the membrane 230 is placed facing the preform 10. The first surface 230a of the membrane 230 is present on the side of the impregnation chamber 201, and the second surface 230b of the membrane 230 is present on the side of the compaction chamber 202.

The membrane 230 can enable a pressure to be applied on the impregnation fluid 5 present in the impregnation chamber 201 in order for said impregnation fluid 5 to penetrate into the fibrous preform 10. The membrane 230 can also enable a compacting pressure to be applied on the fibrous preform 10 arranged in the impregnation chamber 201, in order to reduce the expansion of said preform. The pressure applied by the membrane 230 is produced by the compression fluid 6 which, by applying a pressure on the membrane 230, deforms the membrane 230 against the fibrous preform 10. The pressure applied by the compression fluid 6 on the membrane 230 can also enable said membrane 230 to be held in place against the fibrous preform 10 if the pressure increases in the impregnation chamber 201. Thus, the first surface 230a of the membrane 230 can be intended to be in contact with the fibrous preform 10 when the compaction chamber 202 is filled by the compression fluid 6. Thus the first surface 230a of the membrane 230 is preferably smooth. The first surface 230a of the membrane 230 may not have any grooves.

Preferably, as illustrated in FIGS. 1 to 6, the membrane separates a first part 210 of the mould 200 and a second part 220 of the mould 200, the second part 220 of the mould 200 being able to correspond to a cover. Thus, the first part 210 of the mould comprises the one or more inlet orifices 211 of the impregnation chamber 201, and comprises the one or more possible outlet orifices 212 of the impregnation chamber 201. The second part 220 of the mould 200 comprises the one or more inlet orifices 221 of the compaction chamber 202, and comprises the one or more outlet orifices 222 of the compaction chamber 202. Thus, the first part 210 of the mould 200 and the membrane 230 delimit the impregnation chamber 201. In particular, the internal walls of the first part 210 of the mould 200 and the first face 230a of the membrane 230 delimit the impregnation chamber 201. Similarly, the second part 220 of the mould 200 and the membrane 230 delimit the compaction chamber 202. In particular, the internal walls of the second part 220 of the mould 200 and the second face 230b of the membrane 230 delimit the compaction chamber 202. Thus, the compaction chamber 202 is delimited by an upper wall 202a opposite the membrane 230, and by two opposite side walls 202b, 202d connecting the upper wall 202a to the membrane 230.

The membrane 230 extends in length in a longitudinal direction D_{L} and in width in a transverse direction D_{T}, as illustrated in FIG. 2. The membrane 230 extends in thickness in a thickness direction D_{E}, perpendicular to the longitudinal direction D_{L} and transverse direction D_{T}.

The membrane 230 is for example made of silicone, or for example made of an elastomer material, for example rubber. The membrane 230 can be reinforced by glass fibres or polyester fibres. The membrane 230 must be produced from a material that is resistant to the temperatures to which said membrane 230 may be subjected during the complete method, as well as to the fluids with which the membrane 230 will be in contact. The membrane 230 must have a compressibility that is coherent with the dimensional tolerance desired for the part. For example, the membrane 230 can have an average thickness between 2 mm and 15 mm in the thickness direction D_{E}, and preferably between 3 mm and 7 mm in the thickness direction D_{E}. In the case of fibrous preforms with complex geometry, for example fibrous preforms having concave shapes, the thickness of the membrane can be increased locally in order to limit the quantity of compression fluid to be injected. For example, the thickness of the membrane can be up to 30 mm in order to adapt to particular points of the fibrous preform.

In accordance with the invention, the membrane 230 comprises a plurality of grooves 235a, 235b on its second surface 230b. These grooves 235a, 235b are channels, troughs or furrows present on the second surface 230b of the membrane 230. The grooves 235a, 235b do not open on the first surface 230a of the membrane 230, and consequently the grooves 235a, 235b do not open into the impregnation chamber 201. The grooves 235a, 235b have a width and a depth sufficient to enable the circulation of the one or more compression fluids 6 inside said grooves 235a, 235b. The grooves can have a width and a depth of several millimetres.

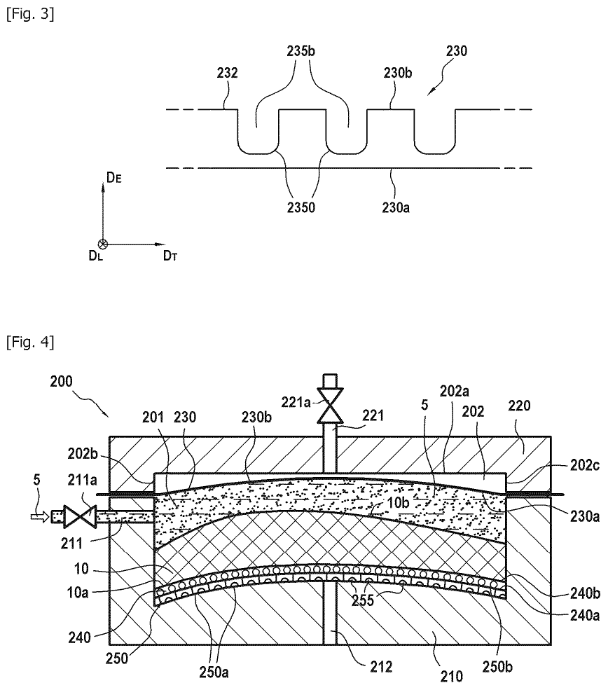

The grooves 235a, 235b can be grooves of rectangular cross-section with projecting edges, or grooves of rectangular cross-section with rounded edges 2350, referred to as a “U-shaped” cross-section, as illustrated in FIG. 3. The grooves 235a, 235b can have a semi-circular cross-section. The cross-sections here belong to a plane perpendicular to the membrane. The grooves 235a, 235b are preferably hollowed out in the thickness of the membrane 230. The thickness of the membrane 230 can be smaller at the grooves 235a, 235b than in the portions of the membrane 230 extending between the grooves 235a, 235b.

The plurality of grooves 235a, 235b can form a network or form a plurality of distinct networks. The grooves 235a, 235b can be interconnected. In particular, the grooves 235a, 235b can form a network covering at least one portion of the membrane 230. The grooves 235a, 235b can form a network covering the majority of the area of the membrane 230. Thus, the membrane 230 can comprise a draining portion 232 which has a plurality of grooves 235a, 235b, and a smooth portion 231 which does not comprise any grooves. Preferably, the smooth portion 231 is present around the draining portion 232. Preferably, the membrane 230 is assembled with the first and second parts 210 and 220 of the mould via the smooth portion 231, the draining portion 232 being free in the absence of pressure or aspiration applied on the membrane 230. Preferably, the grooves 235a, 235b can extend over the entire free portion of the membrane 230, in other words over the entire portion of the membrane 230 which is not fixed to the rigid parts of the mould 200.

The grooves 235a, 235b can form a grid, in other words a first plurality of grooves 235a extends in a first direction and a second plurality of grooves 235b extends in a second direction, different from the first direction. Here, it is considered that the grooves 235a, 235b also form a grid if the first and second directions are not perpendicular. In the example illustrated in FIGS. 2 and 3, the first plurality of grooves 235a extends in the longitudinal direction D_{L} and the second plurality of grooves 235b extends in the transverse direction D_{T}, the longitudinal and transverse directions D_{L} and D_{T} being perpendicular. Thus, in the example illustrated in FIGS. 2 and 3, the grooves 235a, 235b form a straight grid, in other words the first plurality of grooves 235a and the second plurality of grooves 235b extend in perpendicular directions D_{L} and D_{T}.

A membrane 230 having grooves 235a, 235b forming a grid, enables very efficient circulation of the compression fluid 6, in particular when the membrane 230 is pressed against a rigid wall of the mould, while being very easy to manufacture.

The arrangement of grooves 235a, 235b on the second surface 230b of the membrane 230 is preferably adapted to the configuration of the compaction chamber 202 and to the arrangement of the one or more outlet orifices 221 of the compaction fluid 6. Thus, the grooves 235a, 235b can be disposed such that, when the membrane 230 is in contact with one or more outlet orifices 221 of the compaction chamber 202 during the aspiration step, at least one groove 235a, 235b opens into at least one of the outlet orifices 221 with which the membrane 230 is in contact.

The grooves can be disposed such that, when the membrane 230 is in contact with one or more walls of the compaction chamber 202 comprising one or more outlet orifices of the compaction chamber 202 during the aspiration step, the portion of the membrane 230 in contact with the one or more walls comprises a network of grooves 235a, 235b which opens, on the one hand, into at least one of the outlet orifices with which the membrane 230 is in contact and, on the other hand, into a space of the compaction chamber 202. The network of grooves thus comprises at least one path connecting one of the outlet orifices to a space of the compaction chamber 202. Thus the impregnation fluid present in said space of the compaction chamber 202 can circulate to at least one of the outlet orifices due to the network of grooves.

In addition, the grooves 235a, 235b can be disposed such that, when the membrane 230 is in contact with one or more walls of the compaction chamber 202 not comprising an outlet orifice during the aspiration step, so as to separate the compaction chamber 202 into at least two spaces separated by the membrane, the portion of the membrane 230 in contact with the one or more walls comprises a network of grooves which opens, on the one hand, into one of the spaces of the compaction chamber 202 and, on the other hand, into another of the spaces of the compaction chamber 202. The network of grooves thus comprises at least one path connecting the two spaces of the compaction chamber 202 separated by the membrane 230. Thus the impregnation fluid present in one of the spaces of the compaction chamber 202 not comprising an outlet orifice and closed by the membrane 230, can circulate to at least one space of the compaction chamber 202 comprising at least one outlet orifice due to the network of grooves.

More generally, the grooves are disposed such that, when the membrane 230 is in contact with a wall of the compaction chamber 202 during the aspiration step, at least one portion of the grooves opens into at least one outlet orifice or into a space of the compaction chamber comprising at least one outlet orifice. The circulation of the impregnation fluid 5 to an outlet orifice 221 is therefore facilitated during the aspiration step, in particular when the membrane 230 comes into contact with an outlet orifice, as illustrated in FIG. 6, or when the membrane 230 separates the compaction chamber 202 into at least two spaces, one of the spaces not comprising an outlet orifice.

Preferably, the bottom of the grooves follows an inclined trajectory with respect to the plane comprising the longitudinal D_{L} and transverse D_{T} directions, said trajectory being directed towards at least one outlet orifice, in order to further facilitate the flow of the impregnation fluid.

After having placed the fibrous preform 10 in the impregnation chamber 201, the first and second parts 210 and 220 of the mould 200 as well as the membrane 230 are suitably arranged, as previously described and as illustrated in FIG. 1.

As illustrated in FIG. 4, an impregnation fluid 5 is injected into the impregnation chamber 201 via the one or more inlet orifices 211 using an injection device of the impregnation fluid 5. The impregnation fluid 5 can be, for example, a slip comprising precursor matrix particles, or a resin.

If the impregnation fluid 5 is a resin, it can be, for example, an epoxy resin, a carbon precursor resin or a silicon carbide precursor resin.

If the impregnation fluid 5 is a slip, the slip can correspond to a suspension containing a liquid phase and a powder of matrix precursor particles. The liquid phase can, in particular, consist of water, ethanol or any other liquid in which it is possible to place the desired powder in suspension. The pH of the liquid phase of the slip can be adjusted according to the nature of the particles, for example water with an acid pH in the case of alumina powder. An organic binder can also be added (water-soluble PVP or PVA, for example). This binder can ensure the consistency of the raw material, optionally after drying and before sintering. The slip can correspond, for example, to an aqueous suspension consisting of alumina powder for which the average particle size (D50) is between 0.1 μm and 1 μm and for which the volume fraction is between 5% and 50%, the suspension being acidified by nitric acid (pH between 1.5 and 4). In addition to alumina, the refractory oxide particles can also be made of a material chosen from alumina, mullite, silica, an aluminosilicate, an aluminophosphate, zirconia, a carbide, a boride, a nitride and carbon. Depending on their base composition, the refractory oxide particles can in addition be mixed with particles of alumina, zirconia, aluminosilicate, rare earth oxides, rare earth disilicates (used, for example in environmental or thermal barriers) or any other filler enabling specific functions to be added to the final material (carbon black, graphite, silicon carbide, etc.).

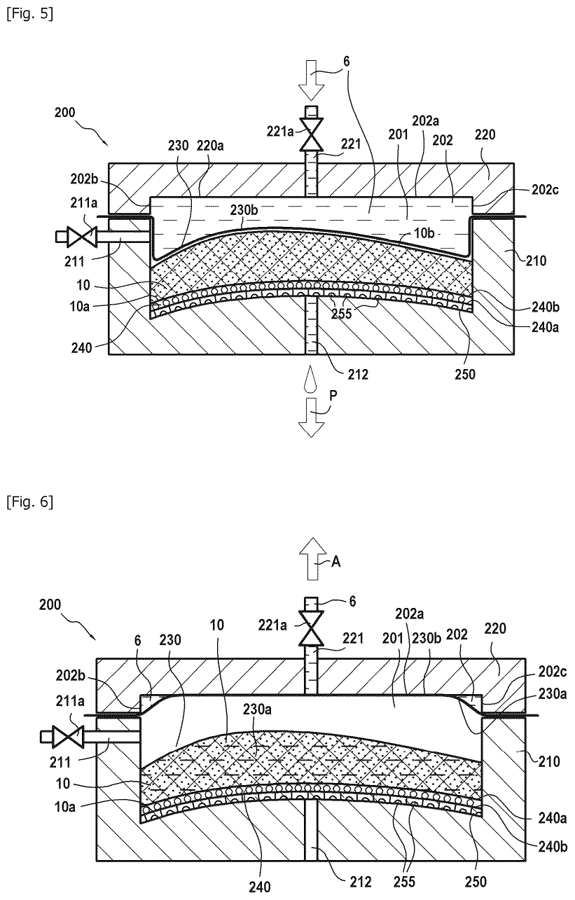

Once the impregnation fluid 5 is injected into the impregnation chamber 201, the compression fluid 6 is then injected into the compaction chamber 202 via the one or more inlet orifices 221 of said compaction chamber 202, as illustrated in FIG. 5, using an injection device of the compression fluid 6. The compression fluid 6 can be water. However, the invention is particularly advantageous in the case where the compression fluid 6 comprises at least one oil, and/or in the case where the compression fluid 6 comprises a substance which may be harmful for health or the environment.

The compression fluid 6 applies a pressure on the impregnation fluid 5 through the membrane 230, which forces said impregnation fluid 5 to penetrate into the fibrous preform 10. The compression fluid 6 imposes a pressure on the whole membrane 230 and, consequently, on the whole of the impregnation fluid 5 present above the preform 10.

In the case where the impregnation fluid 5 is a slip, the pressure applied by the membrane 230 on the slip and on the fibrous preform is preferably reduced, so as to allow the slip to penetrate into the preform 10 and to sufficiently compact said preform 10 in order to enable the liquid phase of the slip to be drained via the filtration layer 240 without degrading the fibrous preform 10. In combination with the application of a pressure on the slip by the compression fluid 6, a pumping P, for example by means of a primary vacuum pump (not shown in FIG. 5), can be carried out at the one or more outlet orifices 212 of the impregnation chamber 201. This pumping is optional. In addition, the tooling 200 can be provided with heating means, such as resistive elements incorporated at the walls of the first and second parts 210 and 220 of the mould 200, in order to increase the temperature in the compaction chamber 202 and to facilitate the removal of the liquid of the slip by evaporation. The filtration layer 240 enables the precursor matrix particles present in the slip to be retained, said particles thus being gradually deposited in the fibrous preform 10. This makes it possible to ultimately obtain the matrix, for example after sintering.

When the fibrous preform 10 is suitably impregnated, it is possible to proceed to a heating or thermal treatment step. For example, in the case where the impregnation fluid 5 is a resin, it is possible to proceed to a polymerisation step of the resin by heating the fibrous preform 10 impregnated by the resin. Preferably, the step of polymerising the resin is performed while the compression fluid 6 present in the compaction chamber 202 continues to maintain a pressure on the membrane 230, and consequently on the fibrous preform 10.

A draining step is then carried out, in which the compression fluid 6 present in the compaction chamber 202 is aspirated via the one or more outlet orifices 221 of the compaction chamber 202, as illustrated in FIG. 6, using an aspiration device A.

In the example illustrated in FIGS. 1 to 6, the inlet and outlet orifice 221 of the compaction chamber 202 is situated on the upper wall 202a of said chamber 202 opposite the membrane 230.

In the case where the outlet orifices and the inlet orifices of the compaction chamber 202 are not coincident, compressed air can be introduced via the one or more inlet orifices of the compaction chamber 202. Preferably, if the one or more inlet orifices of the compaction chamber 202 and the one or more outlet orifices of the compaction chamber 202 are not coincident, the one or more inlet orifices are distant from the one or more outlet orifices. For example, the one or more inlet orifices may be disposed on a first edge of the upper wall 202a of the compaction chamber 202, and the one or more outlet orifices may be disposed on a second edge of said upper wall 202a opposite the first edge. According to another example, the one or more inlet orifices may be disposed on the first side wall 202b of the compaction chamber 202 connecting the upper wall 202a of the compaction chamber 202 to the membrane 230, and the one or more outlet orifices may be disposed on the second side wall 202c of the compaction chamber 202, opposite the first side wall 202b.

Due to the aspiration, the membrane 230 can come into contact with one or more rigid walls 202a of the mould 200, and more precisely into contact with one or more rigid walls 202a of the compaction chamber 202. The presence of grooves 235a, 235b on the second surface 230b of the membrane 230 can force the presence of impregnation fluid 5 at localised locations on the membrane 230. The presence of grooves 235a, 235b on the second surface 230b of the membrane 230 can likewise enable the circulation of the impregnation fluid 5 between the membrane 230 and the one or more walls of the impregnation chamber 202 against which the membrane 230 is pressed. This enables at least one portion of the impregnation fluid 5 to more easily reach the one or more outlet orifices 221 of the compaction chamber 202.

Finally, the impregnated or densified preform is removed from the impregnation chamber 201, which will then be treated in a well-known manner in order to obtain the desired part. The part obtained is, for example, a ceramic matrix composite material (CMC) part or an organic matrix composite (OMC) part. The method according to the invention can enable, for example, the manufacture of an aircraft engine casing or an aeronautical rear body part.

The expression “between . . . and . . . ” should be understood as including the limits.

1. A method for manufacturing a part made of composite material, said method comprising:
arranging a fibrous preform in a mould comprising an impregnation chamber by resting a first face of the preform on a support surface of the impregnation chamber, the impregnation chamber being closed by a flexible membrane placed facing a second face of the preform, said membrane separating the impregnation chamber from a compaction chamber,
injecting an impregnation fluid into the impregnation chamber,
injecting a compression fluid into the compaction chamber so as to apply a pressure on the membrane,
aspiration of the compression fluid present in the compaction chamber via one or more outlet orifices of the compaction chamber,
wherein a surface of the membrane present on a side of the compaction chamber comprises a plurality of grooves.

2. The method according to claim 1, wherein the grooves are disposed such that, when the membrane is in contact with a wall of the compaction chamber, at least one portion of the grooves opens into at least one outlet orifice of the compaction chamber or into a space of the compaction chamber comprising at least one outlet orifice.

3. The method according to claim 1, wherein the grooves are interconnected.

4. The method according to claim 1, wherein the grooves form a two-dimensional network of grooves.

5. The method according to claim 4, wherein the grooves form a grid.

6. The method according to claim 1, wherein the membrane is reinforced by glass fibres or polyester fibres.

7. The method according to claim 1, wherein the compression fluid comprises at least one oil.

8. The method according to claim 1, wherein the impregnation fluid is a resin, the method further comprising a polymerisation step of the resin impregnating the fibrous preform after the steps of injecting impregnation fluid and compression fluid and before the step of aspiration of the compression fluid.

9. The method according to claim 1, wherein the fibrous preform is produced by three-dimensional weaving of fibres.

10. A system for manufacturing a composite material part, said system comprising:
a mould comprising an impregnation chamber including a support surface intended to be in contact with a first face of a preform, the impregnation chamber being closed by a flexible membrane situated facing the support surface, said membrane separating the impregnation chamber from a compaction chamber,
a device for injecting an impregnation fluid into the impregnation chamber,
a device for injecting a compression fluid into the compaction chamber so as to apply a pressure on the membrane,
a device for aspiration of the compression fluid present in the compaction chamber via one or more outlet orifices,
wherein a face of the membrane present on a side of the compaction chamber comprises a plurality of grooves.
